(19) United States
(12) Patent Application Publication
(10) Pub. No.: US 2007/0269081 A1
(43) Pub. Date: Nov. 22, 2007

(54) Apparatus And Method To Make Decoration On An Object Body

(76) Inventor: Itie Liu, Yung-Ho (TW)

Correspondence Address: LIN & ASSOCIATES INTELLECTUAL PROPERTY, P.O. BOX 2339, SARATOGA, CA, 95070-0339, US

(21) Appl. No.: 11/381,535

(22) Filed: May 4, 2006

(51) Int. Cl. G06K 9/00

(52) U.S. Cl. 382/111

(57) ABSTRACT

The present invention provides a new and improved apparatus for making decoration on an object body, and method of using it. The apparatus for making decoration on an object body mainly includes a scanning element, a software utility, and a computer connected to the scanning element. The software utility cooperates with the computer, produces a plurality of decoration parameters, a golden ratio, a stress factor, and makes a suitable or an optimal decoration on the object body according to users' selections from the decoration parameters, the golden ratio, and the stress factor. The designer of making the decoration can thus find an easy way to make self-desire decorating products. This will give people more idea the fitting situation and help people to reduce the time in the fitting room for their suitable products.

### FIELD OF THE INVENTION

The present invention relates to the general art of wearing apparel, and more specifically to an apparatus and method for making decoration on an object body.

### BACKGROUND OF THE INVENTION

In general, people buy the decoration of an object body is from the market or a department store. Also, some people design as well as make their own products by themselves. Decorating the human body in the past has involved techniques. These techniques require a large expenditure of time. There are not many people have the capability to design and to make such decorating products, for examples, clothes, shoes and accessories therefor. Traditionally, only rich, or talent people can enjoy the happiness of customer design.

For many reasons, including economic, any device used to make decoration on an object body should be easy and expeditious to apply, so that the decorating products can be attractive to as many as potential wearers as possible. For example, in the case of footwear, the footwear will encourage people to wear shoes, and will be easily attached to and removed from the shoes.

In the past, for making decoration on an object body, the designer must perform a number of routine procedures simultaneously in order to be successful and provide comfort to the wearer. A good example is a tailor for making a trouser on a human body. Many clear parameters need to consider for the trouser, such as trouser length, trouser depth, waist width, leg end width, and abdomen line. However, such clear and precise fitting parameters may not be labeled in the market or a department store. Instead, a few parameters are labeled, such as small, middle, large, and extra large. And, people put on and off the cloth inside the fitting room in order to buy their suitable products.

The other issue needs to consider for decoration on an object is called golden ratio. This ratio can be the most pleasing to eyes. For the decoration on an object, such as clothes, needs to be good looking when the object is moving. For example, a person is walking, or running during scanning. In the past, however, an object body is scanned in a static way. In other words, the object does not move, and images taken are still. Since each object is unique, and object body is three dimensions, clothes on a body will look better with dynamic golden ratio considered.

Another issue needs also to consider for decoration on an object is called “stress factor (SF)”, which represents how much pressure the decoration to the object body. This is the physical character between the material to make clothes and the stress to pressure the object body. For example, the pressure of the clothes to human body is decided by material, such as cloth, wool, or nylon for the same size. In the past, however, the decoration on an object did not pay attention to such a stress factor. To be able to fit an object body better, “stress factor” should be considered.

Therefore, it would be highly desirable to have a new and improved technique for making decoration on an object body, which not only has the inventive features, but also has added flexibility and comfort to facilitate the wearing of decoration on the object body.

### SUMMARY OF THE INVENTION

Therefore, it is the principle object of the present invention to provide a new and improved apparatus for making decoration on an object body, and method of using it, wherein the body decoration can be based on the newly defined decorating parameters. The designer of making the decoration can thus find an easy way to make self-desire decorating products. This will give people more idea the fitting situation. Also, these newly defined decorating parameters can help people to reduce the time in the fitting room for their suitable products.

Another object to the present invention is to provide such a new and improved apparatus for making decoration on an object body, and method of using it, wherein dynamic golden ratio is developed and also used for a moving object. So, the decoration body will look better when the object is still or moving.

Another object to the present invention is to provide such a new and improved apparatus for making decoration on an object body, and method of using it, wherein stress factor is taken into consideration. For example, stress factor of clothes to human body, such as skin or muscle or bone, will be different from nylon, and may change the clothes parameter. It is material's physical character. And, an object body can be fit better with stress factor considered.

In the embodiment of the present invention, the apparatus for making decoration on an object body includes a scanning element, a computer connected to the scanning element, and a software utility. The computer includes a memory and a processor. The scanning element takes one or more object images on an object body, and the object images are saved into a storage device, such as the memory in the computer. The software utility cooperates with the computer, produces a plurality of decoration parameters, a golden ratio, a stress factor, and makes a suitable or an optimal decoration on the object body according to users' selections from the decoration parameters, the golden ratio, and the stress factor. The software utility may consist of a group of software modules.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a block diagram showing the decoration methodology of the first embodiment of the present invention.

FIG. 2 is a block diagram illustrating the software utility in FIG. 1.

FIG. 3a shows a classification on the decoration parameters.

FIG. 3b shows an example of trousers' clothes parameters that are drawn as a tag on the trousers.

FIG. 4 shows a conversion flow from body parameters to decoration parameters.

FIG. 5A shows the golden ratio of one dimension.

FIG. 5B shows the golden ratio of two dimensions.

FIG. 6 shows the possible applications after clothes parameters are ready.

FIG. 7 shows a flow for decoration parameters including stress factor, wherein clothes is taken as an example of the decoration product.

FIG. 8 shows the application flow by using clothes parameters with one or multiple materials.

FIG. 9 shows relations between decoration parameters, stress factor and golden ratio, wherein clothes is taken as an example of the decoration product.

FIG. 10a and FIG. 10b show a flow from cloth to clothes.

FIG. 11 shows a group of software modules needed for decoration parameters and parameters' application, in which clothes is taken as an example of the decoration product.

### DETAILED DESCRIPTION OF THE PREFERRED EMBODIMENTS

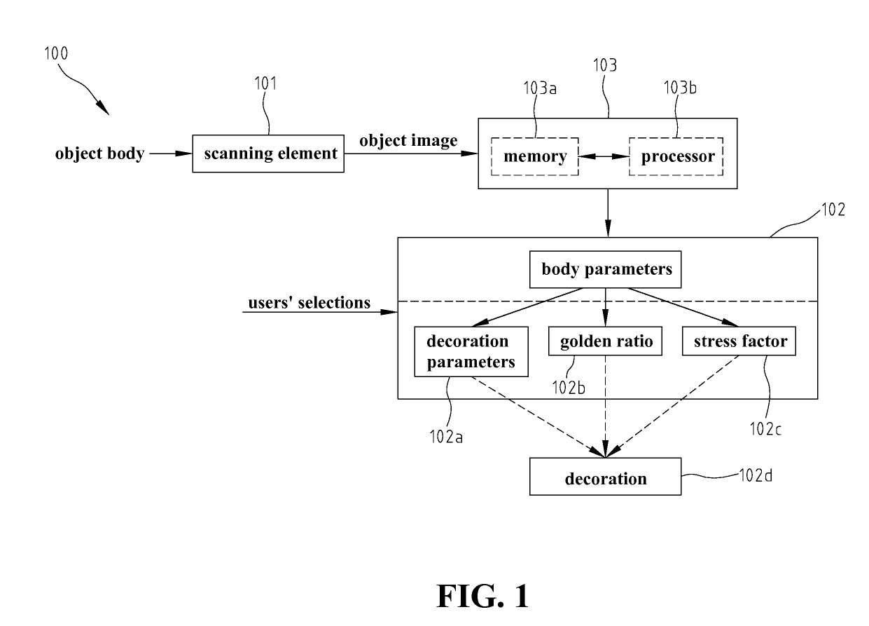

FIG. 1a is a block diagram showing the decoration methodology of the first embodiment of the present invention. Referring to FIG. 1, the apparatus 100 for making decoration on an object body mainly includes a scanning element 101, a utility of software 102, and a computer 103 connected to the scanning element 101. The computer 103 includes a memory 103a, and a processor 103b. The software utility 102 cooperates with the computer 103, produces a plurality of decoration parameters 102a, a golden ratio 102b, a stress factor 102c, and makes a suitable or an optimal decoration 102d on the object body according to users' selections from the decoration parameters 102a, the golden ratio 102b, and the stress factor 102c.

The scanning element 101 takes one or more object images on an object body, and the object images are saved into a storage device, such as memory 103a or hard disk, in the computer 103. The object body can be scanned by two ways, i.e. static and dynamic. Static scan collects images for an object body that does not move. Dynamic scan collects images for an object that is under moving, such as it can collect an object's general moving style (GMS). The scanned data can be one form of body parameters (body P) needed to draw a three-dimensional image of the object body, such as image file, parameters, and other information used inside the apparatus. In addition, the data may be protected via security techniques, such as password, fingerprint, and other suitable tool.

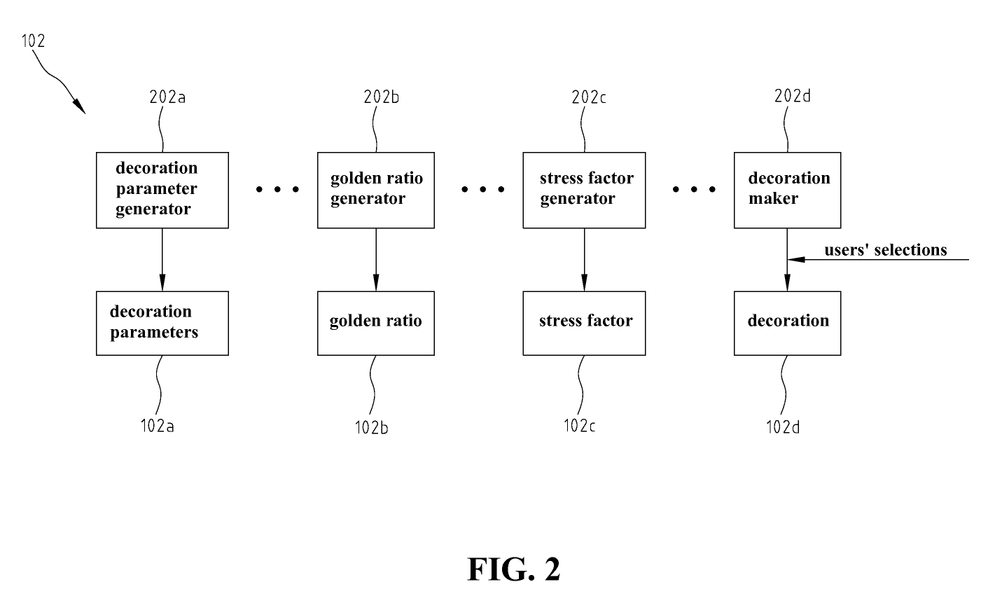

As shown in FIG. 2, the software utility 102 may consist of a group of software modules that include at least a decoration parameter generator 202a, a golden ratio generator 202b, a stress factor generator 202d, and a decoration maker 202d. The decoration parameter generator 202a converts the object images to the plurality of decoration parameters 102a needed to decorate an object body. The golden ratio generator 202b generates the golden ratio 102b of an object body, i.e. the most suitable ratio of an object body (MSRO). The stress factor generator 202c measures how much pressure the decoration to the object body. According to users' selections from the generated decoration parameters, golden ratio, and stress factor, the decoration maker 202d makes the suitable or optimal decoration 102d on the object body.

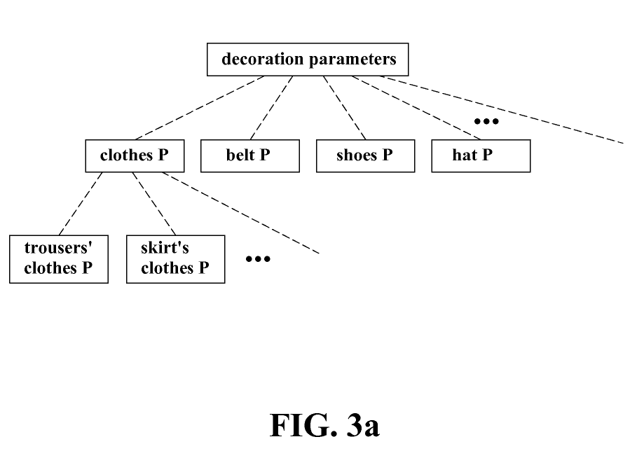

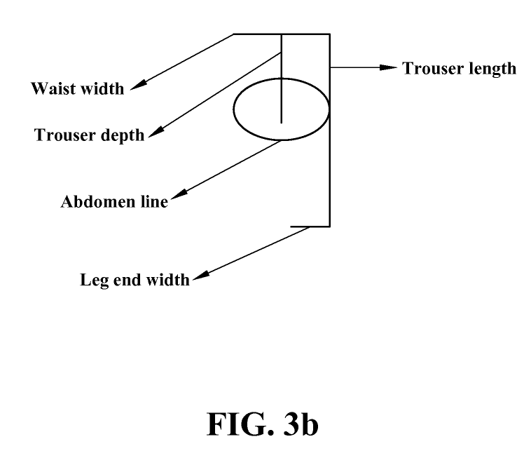

As shown in FIG. 3a, the decoration parameters can be partitioned into a plurality of classes, such as clothes parameters (clothes P), belt parameters (belt P), shoes parameters (shoes P), hat parameters (hat P), . . . , etc. A class of decoration parameters may further include one or more subclasses of decoration parameters. For example, clothes parameters may further include trousers' clothes parameters, skirt's clothes parameters, . . . , etc. Also, subclasses of clothes parameters can be totally or partially different from different clothing. For example, trousers' clothes parameters totally or partially different from skirt's clothes parameters.

Possible clothes parameters are cloth length, sleeve end width, bust line, upper-sleeve width, sleeve length, abdomen line, bust width, shoulder width, trouser leg-end width, trouser length, waist length, neck width, skirt length, butt width, trouser depth, and so on. Trousers' clothes parameters may include trouser length, waist length, trouser depth, abdomen line, leg-end width and so on. While skirt's clothes parameters may include skirt's length, waist length, and butt width.

Moreover, a class or subclass of decoration parameters can have their certain parameters be added on a decorating product. Such parameters are referred to as a decoration product descriptor. A decoration product descriptor is a descriptor for the decoration product. For example, trouser length, waist length, trouser depth, abdomen line and leg-end width, can be formed as a trousers' descriptor and added on the trouser. These parameters are chosen from trousers' clothes parameters. A decoration product descriptor can be represented as many kinds of forms, such as a tag, a sticker, a mark, a stamp, . . . , etc. FIG. 3b shows an example of trousers' clothes parameters that are drawn as a tag on the trousers.

Belt parameters may include waist width, belt length/width, how many holes needed?, . . . , etc. Shoes parameters may include foot print, foot size, foot shape, bone shape, . . . , etc. Hat parameters may include head size, head shape, how much hair?, . . . , etc.

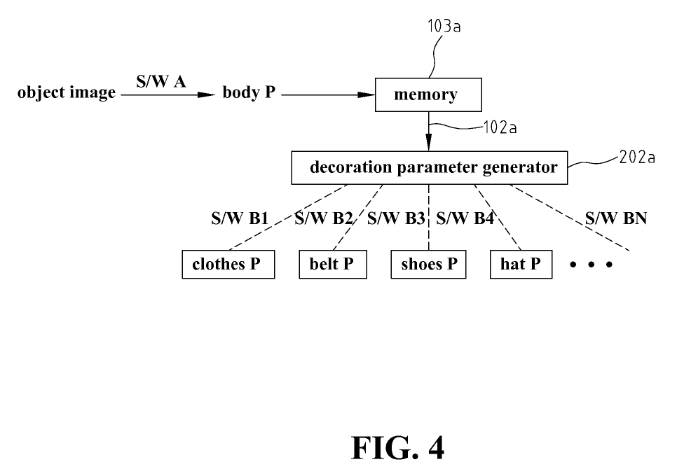

FIG. 4 shows a conversion flow from body parameters to decoration parameters. Referring to FIG. 4, body parameters can be easily obtained via software (S/W) A, and saved into the memory 103a in the computer 103. The software A converts an object image to body parameters. This can be done by the scanning element 101 or the computer 103, or a software module. The decoration parameter generator 202a then converts the body parameters to decoration parameters 102a. According to different decoration products, different decoration parameters are generated by various software modules. For examples, the software B1 generates clothes parameters, the software B2 generates belt parameters, the software B3 generates shoes parameters, and the software B4 generates hat parameters. The decoration parameter generator 202a can be considered as a software series [B1/B2/B3/ . . . /BN]. This will depend on the desired applications.

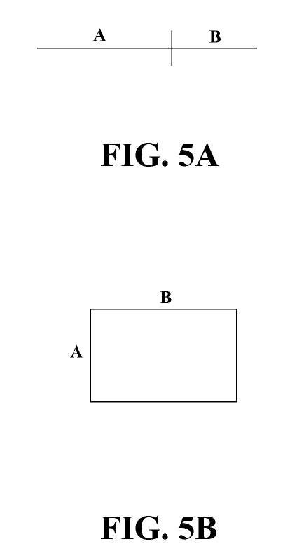

The golden ratio Phi has two levels. One level L1 is considering golden ratio of one and two dimensions, such as line and rectangle. As respectively shown in FIG. 5A and FIG. 5B, golden ratio on a line can be represented as the ratio of longer line divided by shorter line, while golden ratio on a rectangle can be represented as the ratio of length to width of the rectangle. The other level L2 is considering golden ratio of three dimensions, i.e. height by length by width.

The stress factor may change the decoration parameters. It is a materials' physical character. For example, stress factor of cloth to human body, such as skin or muscle or bone, will be different from nylon. The pressure of the clothes to human body can be decided by material, such as cloth, wool, or nylon for the same size. The reason is clothes uses the same size, but uses the different materials that may cause severe stress difference to skin or muscle or bone. With such a stress factor, the decoration on the object body will fit better. Therefore, the present invention includes the stress factor for the decoration on the object body.

The information of the generated decoration parameters, golden ratio, or stress factor will give people more idea the fitting situation. Therefore, the designers of making the decoration will input their own selections from the generated decoration parameters, golden ratio, or stress factor, then make self-desire decorating products. Also, the newly customized decorating information reduces the time in the fitting room for their suitable products.

There are various decoration products on many different objects. Without loss of generality, the detailed description provided herein below takes clothes as an example of the decoration product on a human being.

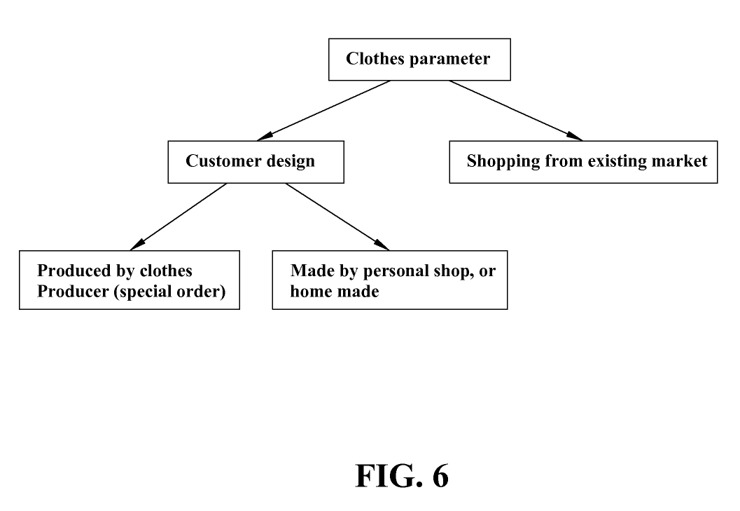

FIG. 6 shows the possible applications after clothes parameters are ready. Referring to FIG. 6, people can find suitable products from the existing market or with a special order (i.e. custom design) by using clothes parameters. Unlike the conventional techniques, making clothing requires a large expenditure of time. Instead, this special order according to the present invention allows the clothes producer, the personal shop or the home made makes clothing by using clothes parameters.

Thus, decoration parameters are used for making a decoration of an object. They can be used for decorating products' making, shopping, and fitting. Decoration parameters may be different from product to product. Moreover, they can be added on a decorating product. The good thing of using decoration parameters is to easily find self-desire products by means of more precise parameters.

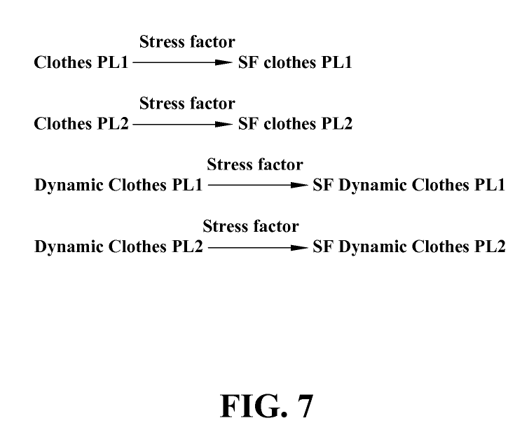

As mentioned earlier, the object body can be scanned by a static or dynamic way. FIG. 7 shows a flow for decoration parameters including stress factor, wherein clothes is taken as an example of the decoration product. As shown in FIG. 7, the object body can be scanned by a static or dynamic way, and the most suitable ratio of an object can have two levels L1 and L2 as mentioned before. There are four kinds of applications for the decoration parameters including stress factor. For examples, the first application in FIG. 7 is employed under a still object for clothes parameters including stress factor using golden ratio L1, while the last application in FIG. 7 is employed under a moving object for clothes parameters including stress factor using golden ration L2. The selection of using golden ratio L1 or L2 can be decided by the users.

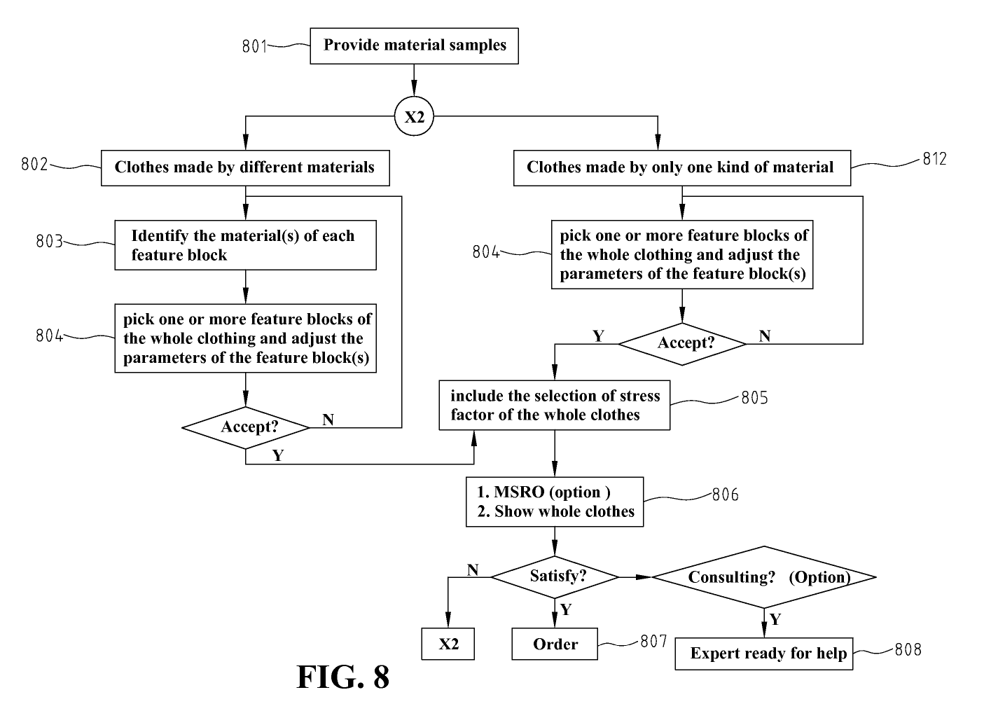

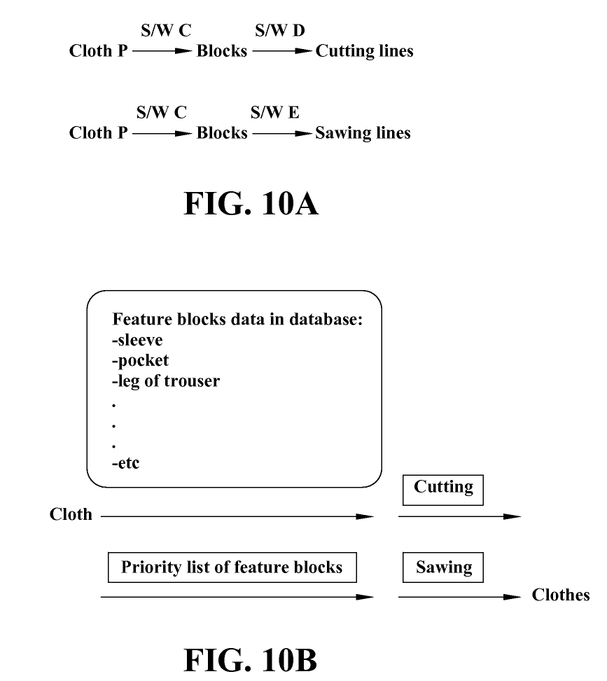

FIG. 8 shows the application flow by using clothes parameters with one or multiple materials. As shown in step 801, materials samples are first provided for making a decorating product, such as clothes. The clothes may be made by different materials or by only one kind of material, as shown in steps 802 and 812 respectively. If the clothes are made by different materials, then step 803 is to identify the material(s) of each feature block. By using the clothes parameters pre-built in a database, users pick one or more feature blocks of the whole clothing and adjust the parameters of the feature block(s) (FIG. 10b will describe feature block in more detail), as in step 804. A feature block's parameters may be size, style, shape, color, . . . , etc. If the selected clothes parameters are acceptable, then step 805 is to include the selection of stress factor of the whole clothes; otherwise, go back to step 803. If the clothes are made by only one kind of material, then same steps for the multiple materials are directly performed except that the step 803 is skipped.

After the stress factor is included, users can optionally take MSRO into consideration and the whole clothes are shown, as illustrated in step 806. This is to allow the users make an order for the clothes or request an expert for help, as shown in steps 807 and 808 respectively. It is worthy to mention that the golden ratio with level 1 or level 2 may be employed under a still or moving object.

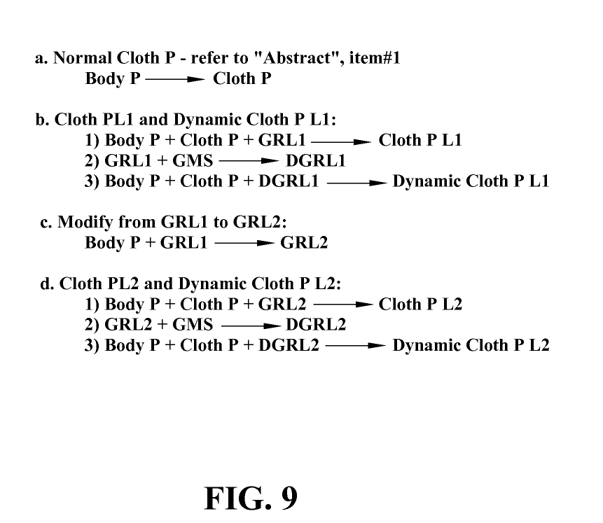

FIG. 9 shows the relations among the body parameter, the decoration parameters, the stress factor and the golden ratio, wherein clothes are taken as an example of the decoration product. Referring to FIG. 9, there are four types a-d of the relations.

For type a, it is referred to normal clothes P, in which the body parameter (Body P) is converted to clothes parameters (Cloth P), i.e. Body P→Cloth P.

For type b, it is referred to clothes parameter using golden ratio L1 and dynamic clothes parameter using golden ration L1. The clothes parameter using golden ratio L1 is denoted by Cloth PL1, in which the body parameter, the cloth parameters, and the golden ratio L1 (denoted by GRL1) are combined and converted to Cloth PL1, i.e. Body P+Cloth P+GRL1→Cloth PL1. The dynamic clothes parameter using golden ratio L1 is denoted by Dynamic Cloth PL1, in which golden ratio L1 and general moving style of an object (denoted by GMS) are first converted to dynamic general golden ratio L1, i.e. GRL1+GMS→DGRL1, then the body parameter, the cloth parameters, and the DGRL1 are combined and converted to the Dynamic Cloth PL1, i.e. Body P+Cloth P+DGRL1→Dynamic Cloth PL1.

For type c, it is referred to Modify from GRL1 to GRL2, in which the body parameter and the golden ratio L1 are converted to golden ratio L2, i.e. Body P+. GRL1→GRL2.

For type d, it is referred to clothes parameter using golden ratio L2 and dynamic clothes parameter using golden ratio L2. The clothes parameter using golden ratio L2 is denoted by Cloth PL2, in which the body parameter, the cloth parameters, and the golden ratio L2 (denoted by GRL2) are combined and converted to Cloth PL2, i.e. Body P+Cloth P+GRL2→Cloth PL2. The dynamic clothes parameter using golden ratio L2 is denoted by Dynamic Cloth PL2, in which golden ratio L2 and general moving style of an object (denoted by GMS) are first converted to dynamic general golden ratio L2, i.e. GRL2+GMS→DGRL2, then the body parameter, the cloth parameters, and the DGRL2 are combined and converted to the Dynamic Cloth PL2, i.e. Body P+Cloth P+DGRL2→Dynamic Cloth PL2.

Using one of the most suitable ratios of an object, i.e. MSRO L1 or L2, as can be seen from type b to type d, the body parameter can be converted to one of Cloth PL1, Dynamic Cloth PL1, Cloth PL2, and Dynamic Cloth PL2. This is illustrated as the followings.
Body P including MSRO L1 or L2→Cloth PL1, Dynamic Cloth PL1, Cloth PL2, or Dynamic Cloth PL2.

Referring back to FIG. 8, it is required to convert a whole piece of clothing to be blocks for single or multiple materials, and users can select self desired blocks' clothes parameters. Therefore, some software modules are employed to define, process, and feature the blocks.

FIG. 10 illustrates a flow from cloth to clothes. This clothes flow requires to define blocks, to process and feature each block, and to combine featured blocks. FIG. 10 is further illustrated by FIG. 10a and FIG. 10b. Referring to FIG. 10a, using cloth parameters, a software C converts whole piece of clothing to be blocks, and a software D converts the blocks to cutting lines. Then cloth is cut to be block(s) based on the cutting lines. While a software E converts the blocks to sawing lines. The featured blocks are combined together based on the sawing lines. The data for processing and featuring blocks, such as sleeve, pocket, leg of trouser, etc, can be stored in a database. After the cloth is cut, a priority list of featured blocks may be formed for further sawing the featured blocks and completing the clothes, as shown in FIG. 10b. FIG. 10b is just an example to make clothes. However, clothing can be made with or without feature blocks according to the present invention.

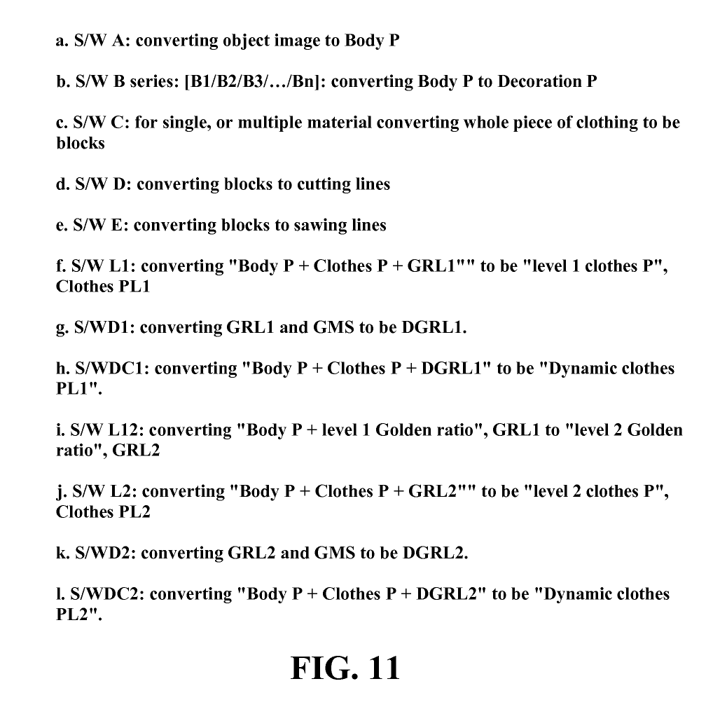

As can be seen from the above description, in operation, the software utility of the present invention consists of a group of software modules needed for decoration parameters and parameters' application. Referring to FIG. 11, there is shown such a group of software modules, in which clothes is taken as an example of the decoration product.

In summary, the present invention provides a new and improved apparatus for making decoration on an object body, and method of using it. The apparatus mainly includes a scanning element, a software utility and a computer. The software utility cooperates with the computer, produces a plurality of decoration parameters, a golden ratio, a stress factor, and makes a suitable or an optimal decoration on the object body according to users' selections from the newly defined decoration parameters, the golden ratio, and the stress factor. The designer of making the decoration can thus find an easy way to make self-desire decorating products.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for making decoration on an object body, comprises:
a scanning element that takes one or more object images on said object body;
a computer connected to said scanning element, and said computer including a memory storing one or more said object images, and a processor; and
a software utility that cooperates with said computer, produces a plurality of decoration parameters, a golden ratio, a stress factor, and makes a suitable or an optimal decoration on said object body according to users' selections from said decoration parameters, said golden ratio, and said stress factor.

2. The apparatus for making decoration on an object body as claimed in claim 1, wherein said software utility consists of a group of software modules that include at least:
a decoration parameter generator that converts said object image to said plurality of decoration parameters needed to decorate said object body;
a golden ratio generator that generates said golden ratio of said object body;
a stress factor generator that measures how much pressure said decoration to said object body; and
a decoration maker that makes said decoration on said object body.

3. The apparatus for making decoration on an object body as claimed in claim 1, wherein said decoration parameters are at least chosen from clothes parameters, belt parameters, shoes parameters, and hat parameters.

4. The apparatus for making decoration on an object body as claimed in claim 1, wherein one or more said object body are both static and dynamic images.

5. The apparatus for making decoration on an object body as claimed in claim 1, wherein said golden ratio has two levels, one level is the golden ratio of one and two dimensions, and the other level is the golden ratio of three dimensions.

6. The apparatus for making decoration on an object body as claimed in claim 1, wherein said stress factor is a materials' physical character.

7. The apparatus for making decoration on an object body as claimed in claim 1, wherein said decoration parameters include a plurality of classes, and each of said classes consists of one or more subclasses.

8. The apparatus for making decoration on an object body as claimed in claim 7, wherein one or more parameters that are chosen from a class or a subclass of said plurality of classes or subclasses, are represented as a decoration product descriptor.

9. The apparatus for making decoration on an object body as claimed in claim 8, wherein said decoration product descriptor is represented as a tag.

10. The apparatus for making decoration on an object body as claimed in claim 8, wherein said decoration product descriptor is represented as a sticker.

11. The apparatus for making decoration on an object body as claimed in claim 8, wherein said decoration product descriptor is represented as a mark.

12. The apparatus for making decoration on an object body as claimed in claim 8, wherein said decoration product descriptor is represented as a stamp.

13. The apparatus for making decoration on an object body as claimed in claim 1, wherein said software utility produces a form of body parameters needed to draw a three-dimensional image of said object body.

14. The apparatus for making decoration on an object body as claimed in claim 1, wherein said software utility produces three types of normal decoration parameters, decoration parameters using said golden ratio, and dynamic decoration parameters using said golden ratio.

15. A method for making decoration on an object body, comprising:
taking one or more object images on said object body;
storing one or more said object images in a storage device of a computer; and
cooperating with said computer, producing a plurality of decoration parameters, a golden ratio, a stress factor, and making a suitable or an optimal decoration on said object body according to users' selections from said decoration parameters, said golden ratio, and said stress factor.

16. The method for making decoration on an object body as claimed in claim 15, wherein said one or more object images are taken in both still and dynamic ways.

17. The method for making decoration on an object body as claimed in claim 15, wherein there are two available levels of said golden ratio employed, one is the golden ratio of one and two dimensions, and the other is the golden ratio of three dimensions.

18. The method for making decoration on an object body as claimed in claim 15, wherein said object image is converted to a form of body parameters needed to draw a three-dimensional image of said object body.

19. The method for making decoration on an object body as claimed in claim 18, wherein said body parameters are converted into three types of normal decoration parameters, decoration parameters using said golden ratio, and dynamic decoration parameters using said golden ratio.
